(19) United States
(12) Patent Application Publication
(10) Pub. No.: US 2005/0169561 A1
(43) Pub. Date: Aug. 4, 2005

(54) Fluid bearing device

(75) Inventors: Takafumi Asada, Hirakata (JP); Tsutomu Hamada, Ozu (JP); Hideaki Ohno, Sennan (JP); Keigo Kusaka, Ozu (JP)

Correspondence Address: AKIN GUMP STRAUSS HAUER & FELD L.L.P., ONE COMMERCE SQUARE, 2005 MARKET STREET, SUITE 2200, PHILADELPHIA, PA, 19103, US

(73) Assignee: Matsushita Electric Industrial Co., Ltd., Kadoma-shi, Osaka (JP)

(21) Appl. No.: 10/512,662

(22) PCT Filed: Mar. 10, 2004
(86) PCT No.: PCT/JP04/03151

(30) Foreign Application Priority Data
Mar. 13, 2003 (JP) 2003-068048
Jun. 19, 2003 (JP) 2003-174362

(51) Int. Cl. F16C 32/06

(52) U.S. Cl. 384/107

(57) ABSTRACT

In order to suppress the increase of torque loss at low temperature and the increase of shaft swinging at high temperature and to improve the workability of the sleeve, high manganese chromium steel or austenitic stainless steel is used as the material of the shaft, sulfur free-machining steel is used as the material of the sleeve, and the surface thereof is coated with plating primarily containing nickel and phosphorus. Hence, it is possible to obtain a hydrodynamic bearing wherein the changes in the characteristics of the bearing owing to the change in the viscosity of a lubricant depending on temperature change can be prevented, in addition, the workability of the sleeve and the dynamic pressure generation grooves and the wear resistance of the bearing can be made best.

### CROSS-REFERENCE TO RELATED APPLICATIONS

This application is a continuation of International Application No. PCT/JP2004/003151, filed Mar. 10, 2004, which was published in the Japanese language on Sep. 23, 2004, under International Publication No. WO 2004/081400 A1 and the disclosure of which is incorporated herein by reference.

### BACKGROUND OF THE INVENTION

The present invention relates to a hydrodynamic bearing which is used in the main shaft portion of a rotation apparatus requiring revolution at a high speed with high accuracy.

In recent years, in rotary recording apparatuses using magnetic discs and the like, their memory capacities are increasing and their data transfer speeds are becoming higher. For these demands, a disc rotation apparatus for use in the kind of recording apparatus is required to rotate at high speed and with high accuracy, whereby a hydrodynamic bearing is used in the rotating main shaft portion thereof.

A conventional hydrodynamic bearing will be described below referring to FIGS. 14 to 18b. In FIG. 14, a shaft 211 is rotatably inserted into the bearing hole 212A of a sleeve 212. The shaft 211 has a flange 213 integral with the lower end portion thereof in the figure. The flange 213 is accommodated in the step portion of the sleeve 212 mounted on a base 217 and configured so as to be rotatable opposing to a thrust plate 214. A rotor hub 218 to which a rotor magnet 220 is fixed is mounted on the shaft 211. A motor stator 219 opposed to the rotor magnet 220 is mounted on the base 217. Dynamic pressure generation grooves 212B and 212C are provided on the inner circumferential face of the bearing hole 212A of the sleeve 212. A dynamic pressure generation groove 213A is provided on the face of the flange 213 facing the step portion of the sleeve 212. A dynamic pressure generation groove 213B is provided on the face of the flange 213 facing the thrust plate 214. Oil is filled in the clearances between the shaft 211 and the flange 213 and the sleeve 212, including the dynamic pressure generation grooves 212B, 212C, 213A and 213B.

The operation of the conventional hydrodynamic bearing configured as mentioned above will be described by using FIGS. 14 to 18b. In FIG. 14, when electric power is applied to the motor stator 219, a rotating magnet field is generated, and the rotor magnet 220, the rotor hub 218, the shaft 211 and the flange 213 start rotating. At this time, pumping pressures are generated in the oil by the dynamic pressure generation grooves 212B, 212C, 213A and 213B, the shaft 211 is floated upward and rotates without making contact with the thrust plate 214 and the inner circumferential face of the bearing hole 212A.

The above-mentioned conventional hydrodynamic bearing had problems described below. As shown in FIG. 14, the shaft 211 rotates while being lubricated with the oil filled inside the bearing hole 212A of the sleeve 212. Generally speaking, as shown in the graph of FIG. 15, when the temperature of the oil lowers, the viscosity of the oil increases exponentially. Since a torque loss in the rotation of the shaft 211 increases in proportion to the viscosity of the oil, the rotation resistance of the shaft 211 is large at low temperature, the torque loss increases and the current consumption of the motor increases. In some cases, the shaft 211 cannot rotate. On the other hand, at high temperature, the viscosity of the oil lowers, whereby the bearing rigidity of the hydrodynamic bearing lowers, thereby causing a defect of increasing “shaft swinging” (a phenomenon wherein the shaft 211 swings inside the bearing hole 212A during rotation) of the shaft 211.

The graph of FIG. 16 shows the change in “radius clearance” depending on temperature, that is the clearance between the outer circumferential face of the shaft 211 and the inner circumferential face of the bearing hole 212A of the sleeve 212 at the time when the axis of the shaft 211 is aligned with the center of the bearing hole 212A. Line IAG in the figure indicates the upper limit value of tolerance, and line JBH indicates the lower limit value of tolerance. The interval between these two lines corresponds to the range of production variation or tolerance.

In this conventional hydrodynamic bearing, martensitic stainless steel (having a linear expansion coefficient of 10.3×10⁻⁶) is used as the material of the shaft 211. In addition, brass (having a linear expansion coefficient of 20.5×10⁻⁶) is used as the sleeve 212. Therefore, the thermal expansion of the sleeve 212 is larger than the thermal expansion of the shaft 211. In the case that the diameter of the shaft 211 is 3.2 mm, for example, the radius clearance increases by about 1 μm when the temperature changes from 20° C. to 80° C. Furthermore, when the temperature changes from 20° C. to −40° C. in a similar way, the radius clearance decreases by about 1 μm. As a result, the radius clearance increases at high temperature as indicated by curve “a” of FIG. 17 so that the rigidity of the bearing lowers and shaft swinging increases, thereby causing a problem of being incapable of obtaining desired performance. On the other hand, at low temperature, the radius clearance decreases reversely, and the rotation resistance increases as indicated by curve “b”, thereby causing a problem of increasing the torque loss.

Theoretically speaking, as the radius clearance increases, the shaft swinging owing to the lowering of the rigidity of the bearing increases in proportion to the third power thereof; and as the radius clearance decreases, the torque loss increases in reverse proportion thereto.

FIG. 18a is a graph showing the relationship between the radius clearance and the torque loss at −40° C., and FIG. 18b is a graph showing the relationship between the radius clearance and the amount of shaft swinging at +80° C. In each figure, required performance ranges are indicated. The examples shown in FIGS. 18a and 18b indicate that the ranges of the torque loss and the shaft swinging with respect to the variation of the radius clearance are not in the ranges satisfying the required performance. In other words, they indicate that the product is defective.

### BRIEF SUMMARY OF THE INVENTION

A hydrodynamic bearing in accordance with a first invention is characterized in that it comprises a sleeve made of a material containing iron and having a bearing hole, the surface thereof being plated with a material containing at least nickel and phosphorus, a shaft relatively rotatably inserted into the bearing hole of the above-mentioned sleeve and made of at least one material of high manganese chromium steel and austenitic stainless steel, and a nearly disc-shaped flange fixed to one end of the above-mentioned shaft, opposed to an end face of the sleeve at one face and opposed to a thrust plate disposed so as to seal an area including the above-mentioned end face of the above-mentioned sleeve at another face, wherein first and second dynamic pressure generation grooves are provided on at least one of the inner circumferential face of the above-mentioned sleeve and the outer circumferential face of the above-mentioned shaft so as to be arranged in a direction along the axis of the above-mentioned shaft, a third dynamic pressure generation groove is provided on at least one of the opposed faces of the above-mentioned flange and thrust plate, the clearance between the bearing hole of the above-mentioned sleeve and the above-mentioned shaft including the above-mentioned first and second dynamic pressure generation grooves and the clearance between the thrust plate and the flange are filled with a lubricant, and either one of the above-mentioned sleeve and the above-mentioned shaft is attached to a fixed base having the stator of an electric motor and the other is attached to a rotation body having the rotor magnet of the above-mentioned electric motor.

According to the present invention, since the radius clearance of the hydrodynamic bearing is small at high temperature and becomes large at low temperature, the changes in the characteristics of the hydrodynamic bearing owing to the change in the viscosity of the lubricant depending on temperature can be prevented. In addition, the wear resistance of the bearing, the workability of the sleeve and the workability of the dynamic pressure generation grooves are good, whereby an accurate hydrodynamic bearing can be obtained.

A hydrodynamic bearing in accordance with a second invention is characterized in that it comprises a sleeve made of a material containing iron and having a bearing hole, the surface thereof being plated with a material containing at least nickel and phosphorus, a shaft relatively rotatably inserted into the bearing hole of the above-mentioned sleeve and made of at least one material of high manganese chromium steel and austenitic stainless steel, and having a shaft end face portion formed of a face perpendicular to the axis thereof at one end, and a thrust plate for forming a thrust bearing by opposing to the above-mentioned shaft end face portion, wherein first and second dynamic pressure generation grooves are provided on at least one of the inner circumferential face of the above-mentioned sleeve and the outer circumferential face of the above-mentioned shaft so as to be arranged in a direction along the axis of the above-mentioned shaft, a third dynamic pressure generation groove is provided on at least one of the respective opposed faces of the above-mentioned shaft end face portion and the above-mentioned thrust plate, the clearance between the bearing hole of the above-mentioned sleeve and the above-mentioned shaft including the above-mentioned first, second and third dynamic pressure generation grooves and the clearance between the above-mentioned shaft end face portion and the above-mentioned thrust plate are filled with a lubricant, and either one of the above-mentioned sleeve and the above-mentioned shaft is attached to a fixed base having the stator of an electric motor and the other is attached to a rotation body having the rotor magnet of the above-mentioned electric motor.

According to the present invention, since the radius clearance of the hydrodynamic bearing is small at high temperature and becomes large at low temperature, the changes in the characteristics of the hydrodynamic bearing owing to the change in the viscosity of the lubricant depending on temperature can be prevented. In addition, the wear resistance of the bearing, the workability of the sleeve and the workability of the dynamic pressure generation grooves are good, whereby an accurate hydrodynamic bearing can be obtained. Furthermore, the above-mentioned third dynamic pressure generation groove is provided on at least one of the above-mentioned shaft end face portion and the above-mentioned thrust plate, thereby forming a thrust bearing portion; hence, the area of the thrust bearing portion is almost the same as the area of the end portion of the shaft. Since the area of the thrust bearing portion is thus smaller than that of the flange in accordance with the first invention, the rotation resistance is smaller, and the torque loss can be suppressed small.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown.

In the drawings:

FIG. 1 is a cross-sectional view of a hydrodynamic bearing in accordance with a first embodiment of the present invention;

FIG. 2 is a cross-sectional view of a sleeve in accordance with the first embodiment of the present invention;

FIG. 3 is a comparison diagram of linear expansion coefficients of materials used for the shaft and the sleeve;

FIG. 4 is a graph showing the relationship between temperature and radius clearance in the first embodiment of the present invention;

FIG. 5a is a graph showing the relationship between radius clearance and torque loss in this embodiment;

FIG. 5b is a graph showing the relationship between radius clearance and shaft swinging in this embodiment;

FIG. 6 is a graph showing the relationship among temperature, torque loss and shaft swinging in this embodiment;

FIG. 7 is a table of ingredients of materials for the shaft and the sleeve in accordance with this embodiment;

FIG. 8 is a table comparing the characteristics of materials for this embodiment and the conventional example;

FIG. 9 is a graph comparing the characteristics of materials for this embodiment;

FIG. 10 is a cross-sectional view of a hydrodynamic bearing in accordance with a second embodiment of the present invention;

FIG. 11 is a graph comparing the torque loss of the hydrodynamic bearing in accordance with the second embodiment of the present invention with the torque loss of the conventional hydrodynamic bearing;

FIG. 12 is a cross-sectional view of a sleeve 102 in accordance with the second embodiment of the present invention;

FIG. 13 is a cross-sectional view of the main portion of a shaft 101 in accordance with the second embodiment of the present invention;

FIG. 14 is the cross-sectional view of the conventional hydrodynamic bearing;

FIG. 15 is the graph showing the relationship between temperature and the viscosity of oil;

FIG. 16 is the graph showing the relationship between temperature and radius clearance in the conventional hydrodynamic bearing;

FIG. 17 is the graph showing the relationship among temperature, shaft swinging and torque loss in the conventional hydrodynamic bearing;

FIG. 18a is the graph showing the relationship between radius clearance and torque loss in the conventional hydrodynamic bearing; and

FIG. 18b is the graph showing the relationship between radius clearance and shaft swinging in the conventional hydrodynamic bearing.

### DETAILED DESCRIPTION OF THE INVENTION

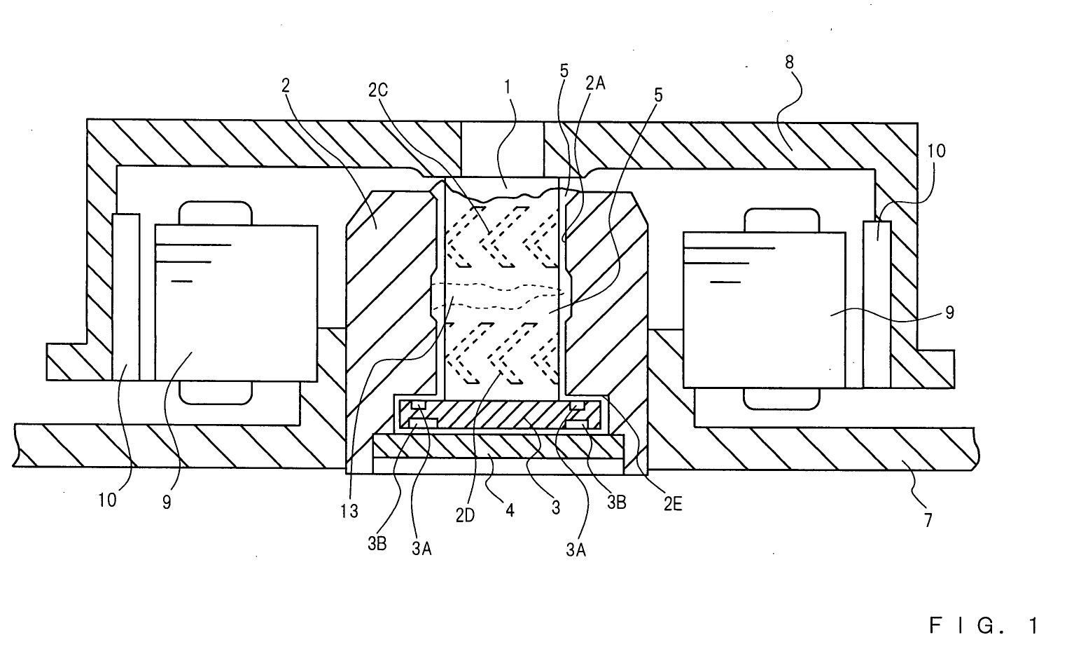

Preferred embodiments of a hydrodynamic bearing in accordance with the present invention will be described below referring to FIGS. 1 to 13.

### First Embodiment

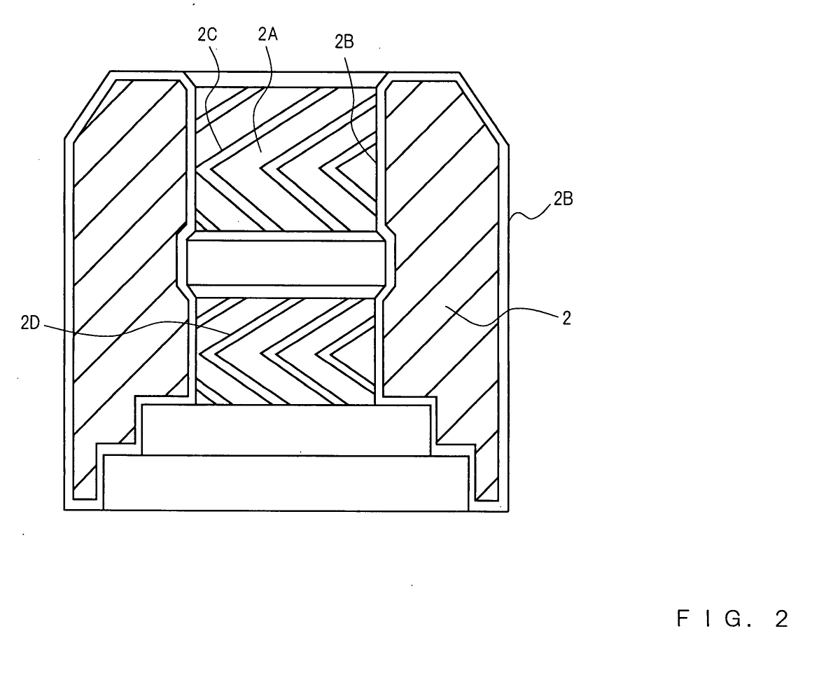

A hydrodynamic bearing in accordance with a first embodiment of the present invention will be described referring to FIGS. 1 to 9. FIG. 1 is a cross-sectional view of the hydrodynamic bearing in accordance with the first embodiment of the present invention, and FIG. 2 is a magnified cross-sectional view of a sleeve 2. In FIG. 1, the sleeve 2 has a bearing hole 2A, and a shaft 1 is rotatably inserted into this bearing hole 2A. Dynamic pressure generation grooves 2C and 2D which are configured by herringbone-pattern-shaped shallow grooves are formed on at least one of the outer circumferential face of the shaft 1 and the inner circumferential face of the bearing hole 2A of the sleeve 2, whereby a radial bearing portion is formed. In the example shown in FIG. 1, the dynamic pressure generation grooves 2C and 2D are formed on the inner circumferential face of the bearing hole 2A. Both the dynamic pressure generation grooves 2C and 2D are fishbone-shaped (herringbone-shaped); in FIG. 1, in at least one of the dynamic pressure generation grooves 2C and 2D, the length of the groove on the lower side from the bent portion is made shorter than the length of the groove on the upper side from the bent portion. A rotor hub 8 having a rotor magnet 10 is mounted to the upper end of the shaft 1 in FIG. 1. A flange 3 having a face perpendicular to the axis of the shaft 1 and having a diameter larger than that of the shaft 1 is integrally provided at the lower end of the shaft 1 in FIG. 1. The lower face of the flange 3 serving as the thrust bearing face is opposed to a thrust plate 4 fixed to the sleeve 2. On either one of the lower face of the flange 3 and the upper face of the thrust plate 4 (the lower face of the flange 3 in FIG. 1), a dynamic pressure generation groove 3B having a spiral shape or a fishbone shape (a herringbone shape) is formed, whereby a thrust bearing portion is configured. On either one of the outer circumferential portion of the upper face of the flange 3 and the end face 2E of the sleeve 2 opposed to the outer circumferential portion of the above-mentioned upper face (the upper face of the flange 3 in FIG. 1), a dynamic pressure generation groove 3A is formed. The sleeve 2 is fixed to a base 7 on which a motor stator 9 is mounted. The gap between the shaft 1 and the sleeve 2 and the gap between the flange 3 and the thrust plate 4 are filled with a lubricant 5, such as oil. Since the lubricant has a certain viscosity, air bubbles 13 may be generated between the shaft 1 and the bearing hole 2A.

In this embodiment, the shaft 1 is produced by subjecting a material, such as high manganese chromium steel containing 7 to 9 wt % of manganese and 13 to 15 wt % of chromium or austenitic stainless steel (containing 8 to 10 wt % of nickel and 17 to 19 wt % of chromium), to machining or the like. Moreover, the sleeve 2 is produced by subjecting sulfur free-machining steel to machining or the like. After the machining, the surface of the sleeve 2 is plated with a material primarily containing nickel and phosphorus, whereby a plated layer 2B having a uniform thickness is formed as shown in FIG. 2. The thickness of the plated layer 2B is selected appropriately in the range of 1 to 20 μm, although it is drawn thick without hatching in FIG. 2.

The operation of the hydrodynamic bearing configured as mentioned above will be described referring to FIGS. 1 to 9. In FIG. 1, when electric power is applied to the motor stator 9 from a power source not shown, a rotating magnet field is generated, and the rotor hub 8 equipped with the rotor magnet 10 starts rotating together with the shaft 1. When the rotation speed rises to a certain extent, pumping pressures are generated in the lubricant, such as oil, by the dynamic pressure generation grooves 2C, 2D, 3A and 3B, and the pressures rise at the radial bearing portion and the thrust bearing portion. As a result, the shaft 1 is floated upward and rotates accurately without making contact with thrust plate 4 and the sleeve 2.

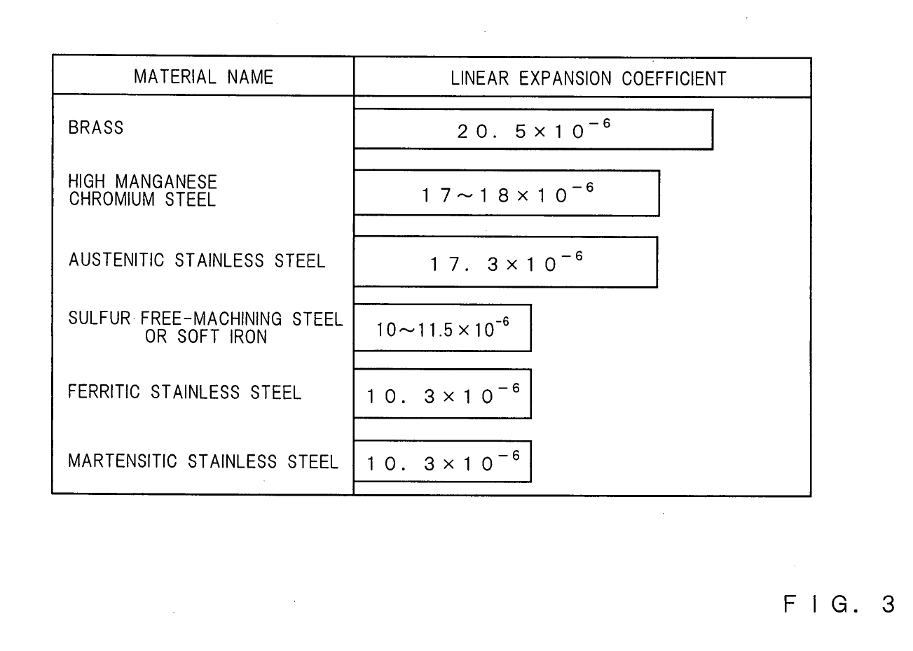

FIG. 3 is a graph showing the measurement values of the linear expansion coefficients of various metal materials suited as the materials of the shaft 1 and the sleeve 2. The numeric values in the boxes represent linear expansion coefficients. Three kinds of materials, that is, high manganese chromium steel, austenitic stainless steel and martensitic stainless steel, are materials usable for the shaft 1. Three kinds of materials, that is, brass, sulfur free-machining steel and ferritic stainless steel, are materials usable for the sleeve 2. In this embodiment, high manganese chromium steel having a high linear expansion coefficient (having a linear expansion coefficient of 17 to 18×10⁻⁶) or austenitic stainless steel (having a linear expansion coefficient of 17.3×10⁻⁶) is used as the material of the shaft 1. In addition, sulfur free-machining steel having a low linear expansion coefficient (having a linear expansion coefficient of 10 to 11.5×10⁻⁶) and excellent workability is used as the material of the sleeve 2. Brass is not suited since its linear expansion coefficient is too high.

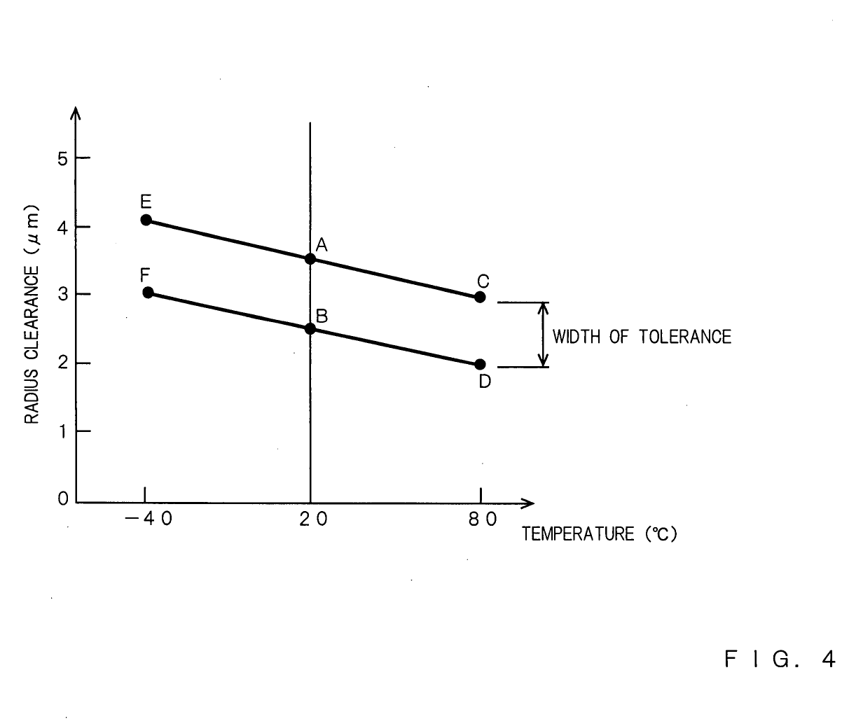

FIG. 4 shows the change depending on temperature in “radius clearance” which is defined as the clearance between the shaft 1 and the bearing hole 2A at the time when the center axis of the shaft 1 is aligned with the center axis of the bearing hole 2A of the sleeve 2. Line EAC indicates the upper limit value of tolerance, and line FBD indicates the lower limit value of tolerance; the distance between these two lines corresponds to the width of tolerance. The width of tolerance is a result obtained by measuring a plurality of hydrodynamic bearings in accordance with this embodiment.

In this embodiment, the shaft 1 is made of a material having a high linear expansion coefficient, and the sleeve 2 is made of a material having a linear expansion coefficient lower than that of the material of the shaft 1; hence, the radius clearance becomes large when the temperature of the hydrodynamic bearing is low, and the radius clearance becomes small when the temperature is high. FIG. 4 shows the measurement data of the hydrodynamic bearing in accordance with this embodiment in the case when the diameter of the shaft 1 is 3.2 mm. As shown in FIG. 4, when the temperature changes from 20° C. to 80° C., the radius clearance becomes smaller by about 0.65 μm. When the temperature changes from 20° C. to −40° C., the radius clearance becomes larger by about 0.65 μm. Since the radius clearance changes depending on the temperature as described above, the following effects are obtained. At high temperature, the viscosity of the lubricant lowers; however, the radius clearance becomes small (narrows) owing to the difference in thermal expansion between the shaft 1 and the sleeve 2. Hence, even if the viscosity of the lubricant lowers, the lowering in the bearing rigidity of the hydrodynamic bearing is reduced, and an effect of preventing shaft swinging is obtained. On the other hand, at low temperature, the viscosity of the lubricant rises, but the radius clearance expands. Hence, the increase of the torque loss owing to the rising of the viscosity is restricted, and the rotation resistance of the bearing is prevented from increasing. Theoretically speaking, the rigidity of the bearing or the shaft swinging can be improved in proportion to the third power of the radius clearance. On the other hand, the torque loss of the bearing is reduced in reverse proportion to the radius clearance.

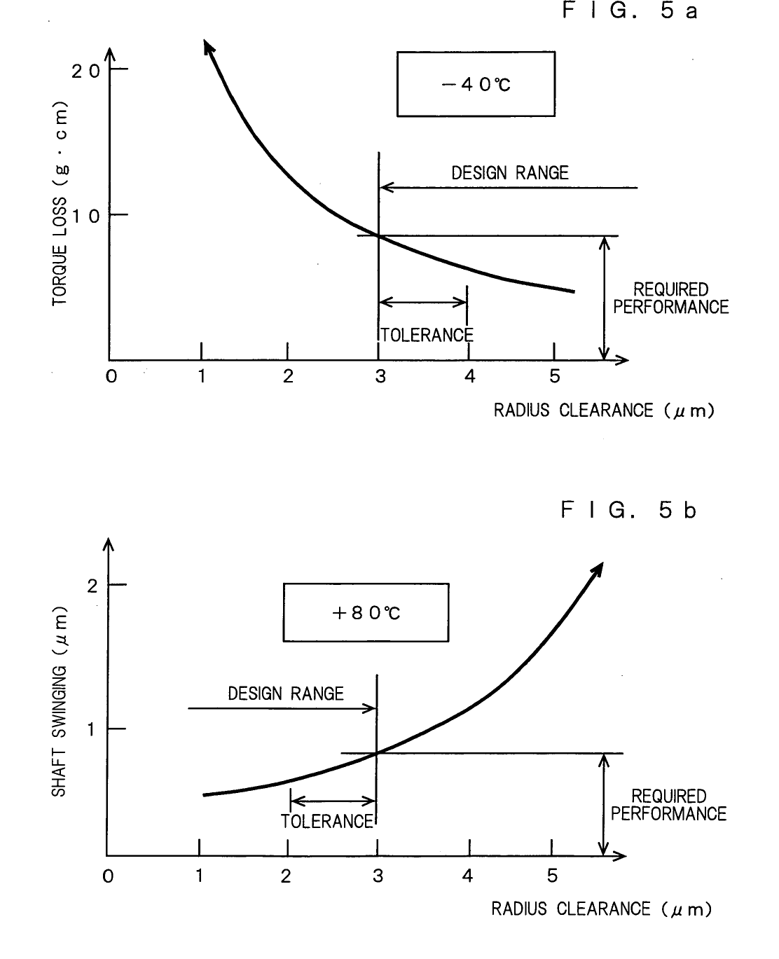

FIG. 5a is a graph showing the relationship between the radius clearance and the torque loss at −40° C. FIG. 5b shows the relationship between the radius clearance and the shaft swinging at +80° C. FIGS. 5a and 5b show the tolerance of the radius clearance at the time when a plurality of hydrodynamic bearings in accordance with this embodiment were measured. When the temperature of the hydrodynamic bearing is −40° C., the radius clearance is in the range of about 3 μm to about 4 μm as shown in FIG. 5a; when the temperature is +80° C., the radius clearance is in the range of about 2 μm to about 3 μm as shown in FIG. 5b. Since the radius clearance at −40° C. is in the range of 3 μm to 4 μm as shown in FIG. 5a, the torque loss has a relatively small value of 10 gcm or less, thereby satisfying the required performance. In addition, since the radius clearance at +80° C. is in the range of 2 μm to 3 μm as shown in FIG. 5b, the shaft swinging is in a relatively small range, thereby satisfying the required performance. Hence, in designing a hydrodynamic bearing, it is understood that the lower limit value of the radius clearance should be set at 3 μm at −40° C. and that the upper limit value of the radius clearance should be set at 3 μm at +80° C. As mentioned above, in the hydrodynamic bearing in accordance with the present invention, even in the case when the radius clearance has a certain tolerance, the entire quantity of products can satisfy the required performance. In other words, 100% of production can be made nondefective, and 100% yield can be attained.

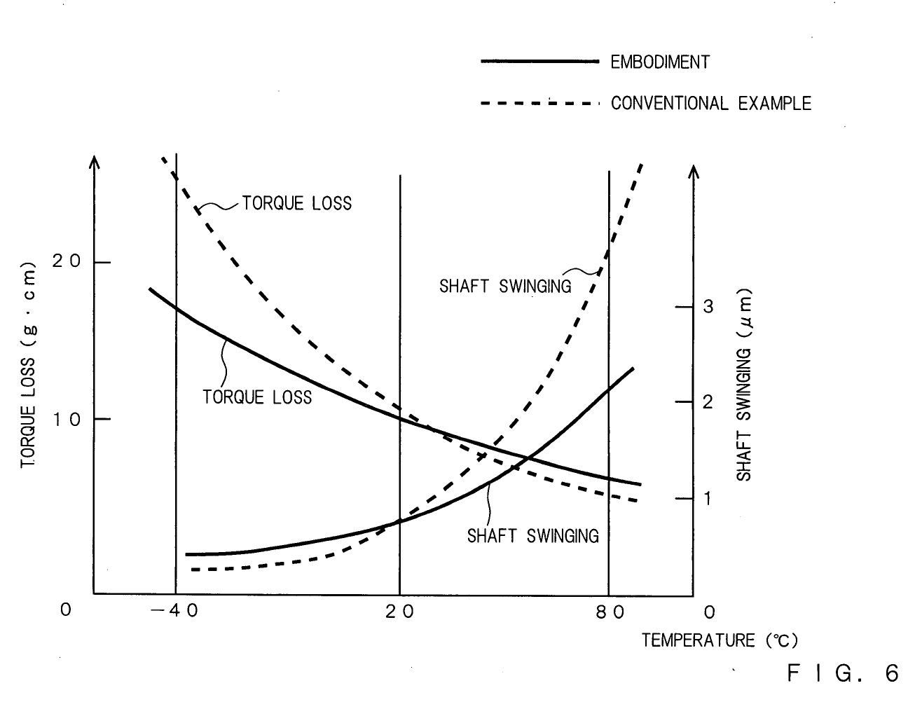

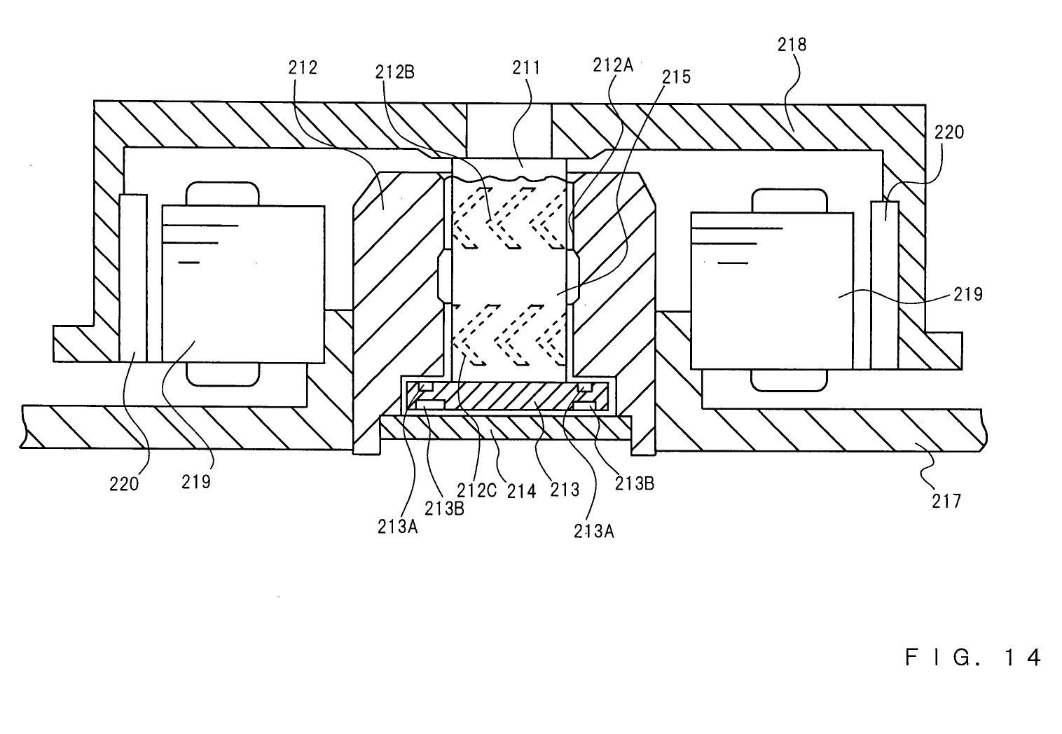

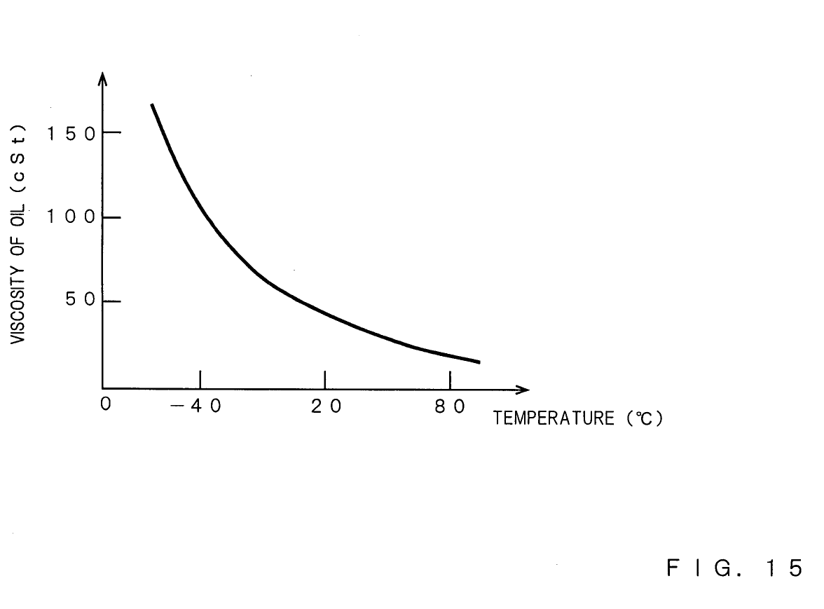

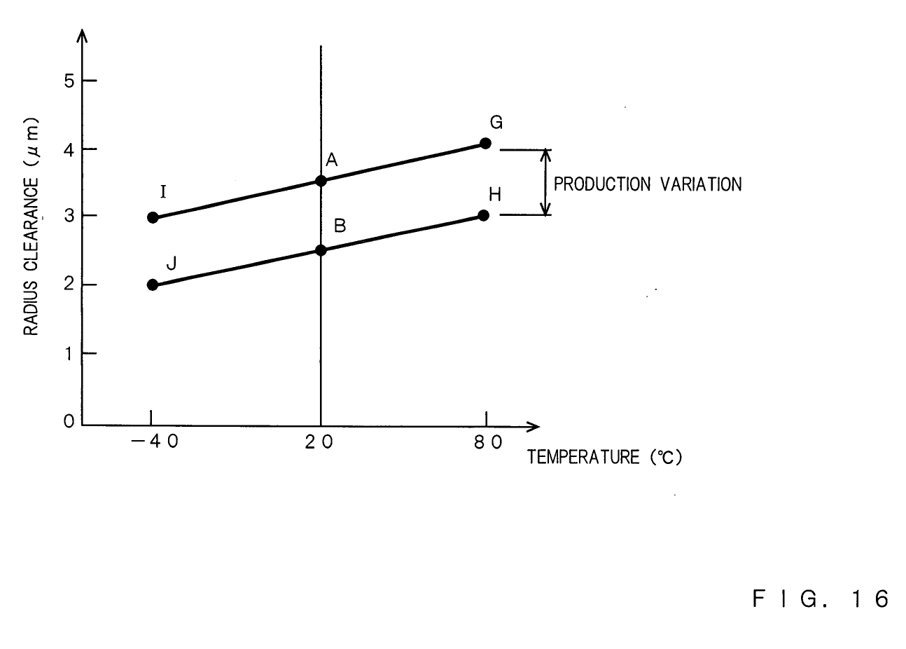

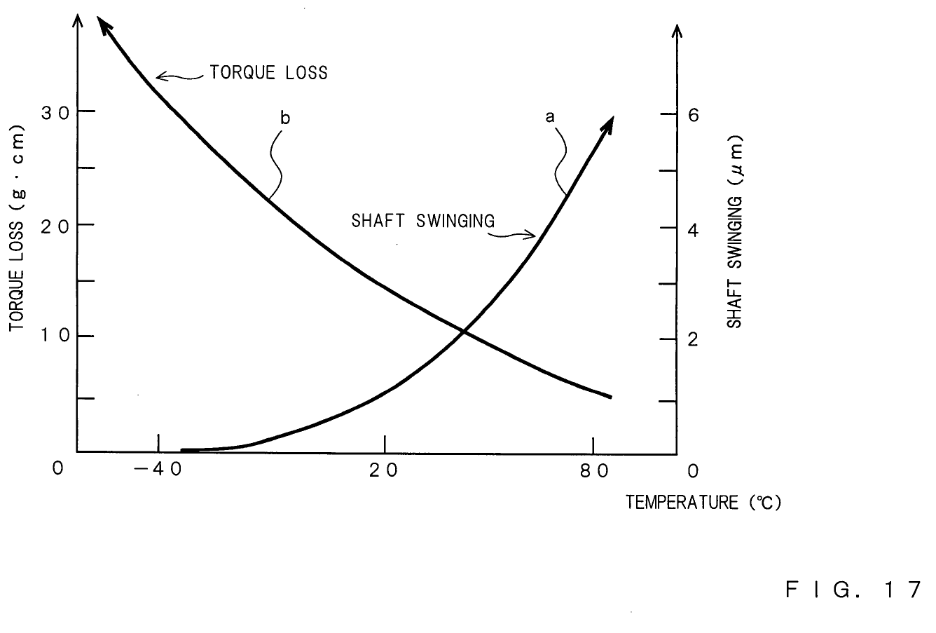

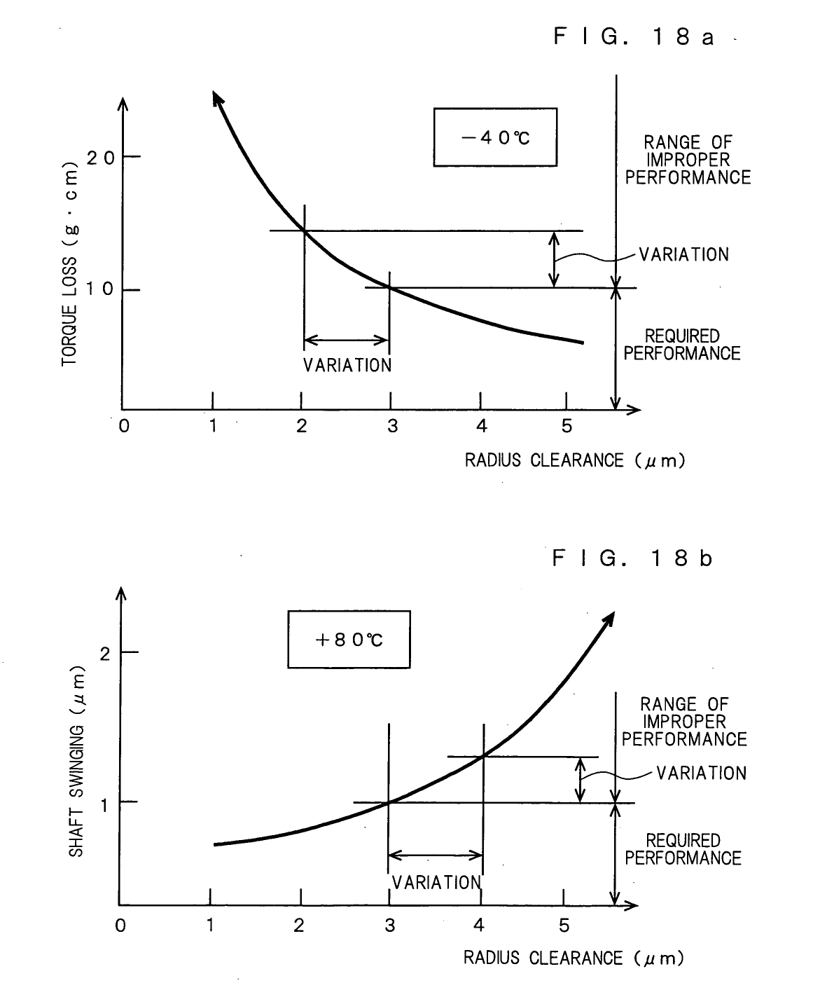

FIG. 6 is a graph showing comparison of the characteristics of the hydrodynamic bearing in accordance with the present invention with the characteristics of the hydrodynamic bearing of the conventional example shown in FIG. 14. In the figure, the solid lines indicate the characteristics of the hydrodynamic bearing in accordance with this embodiment, and the broken lines indicate the characteristics of the hydrodynamic bearing of the conventional example. As understood from FIG. 6, in the hydrodynamic bearing in accordance with this embodiment, the torque loss at low temperature is suppressed so as to be smaller than that of the conventional example. In addition, the shaft swinging at high temperature is also suppressed so as to be smaller than that of the conventional example.

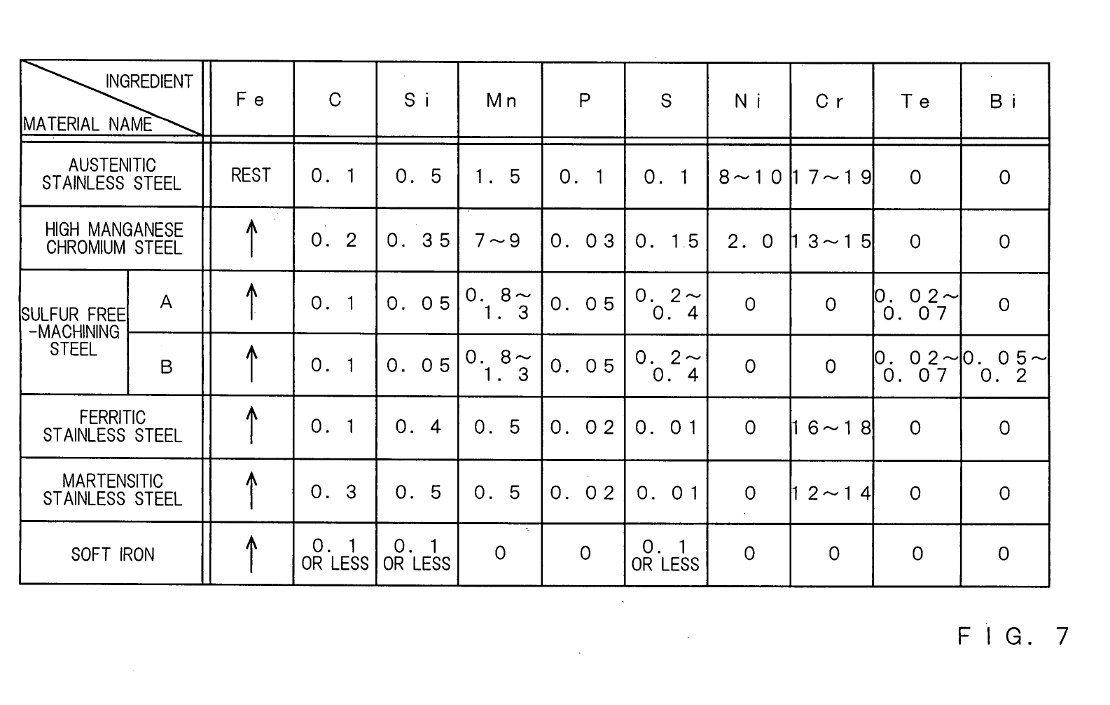

FIG. 7 is a table of ingredients of materials for the shaft 1 and the sleeve 2 in the hydrodynamic bearing in accordance with this embodiment, and each numeric value represents weight %.

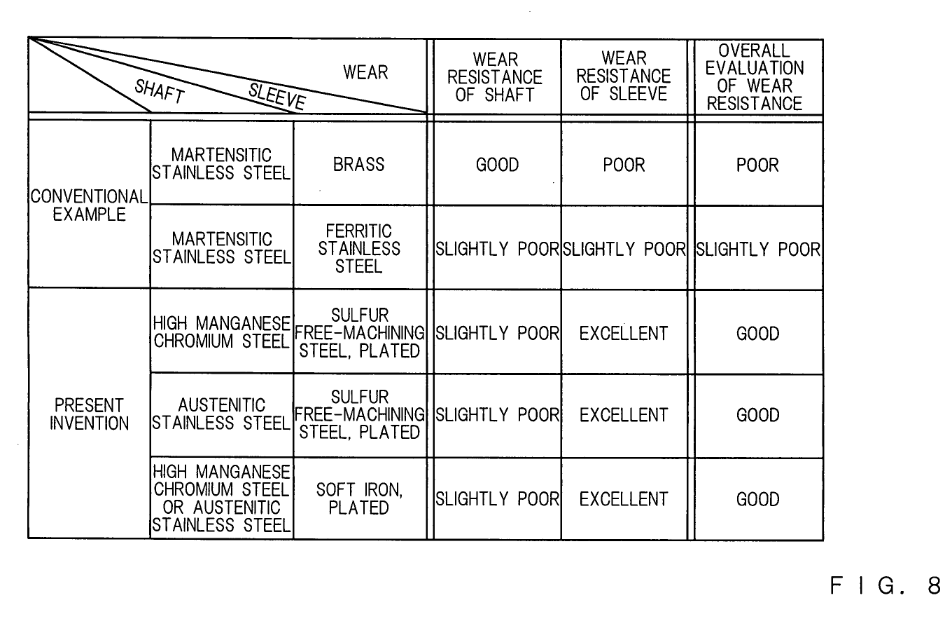

FIG. 8 is a table showing the combinations of metal materials for the shaft 1 and the sleeve 2 in the hydrodynamic bearing of the conventional example and the hydrodynamic bearing in accordance with this embodiment and also showing the evaluation results obtained by comparing and testing the wear resistances of the shaft 1 and the sleeve 2 in the combinations. In the hydrodynamic bearing in accordance with this embodiment, since the surface of the bearing hole 2A of the sleeve 2 is plated with a material primarily containing nickel and phosphorus, its wear resistance is very excellent, and the long-term reliability of the hydrodynamic bearing is high.

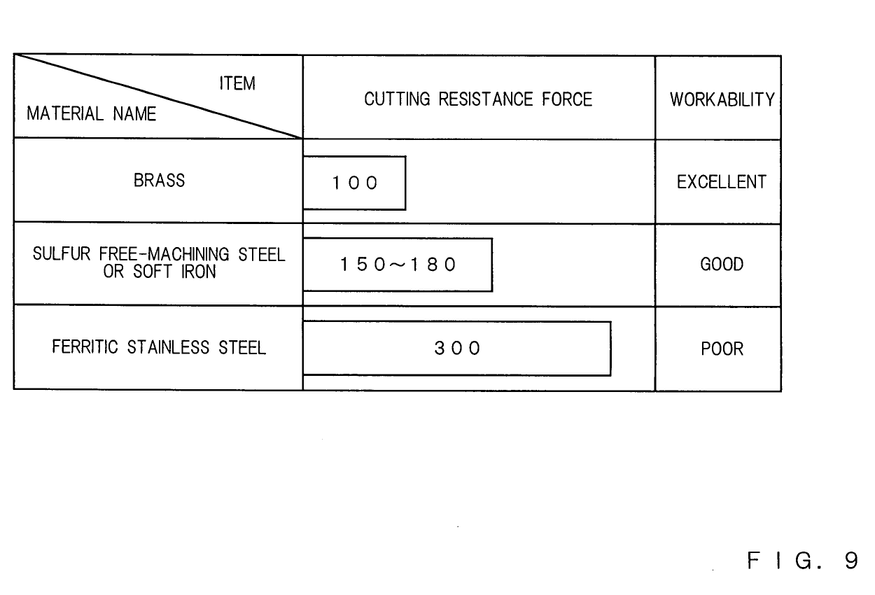

FIG. 9 is a graph showing the results obtained by measuring cutting resistance during machining of metal materials for the sleeve 2 in accordance with this embodiment and also showing the evaluation of workability. The respective numeric values have been normalized assuming that the value of brass is “100.” In the figure, since 100 of the cutting resistance of brass is small, its workability is excellent; however, it is not suited since its linear expansion coefficient is too large as shown in FIG. 3. Since ferritic stainless steel has large cutting resistance of 300 and poor workability, the surface of the bearing hole of the sleeve 2 cannot be machined so as to become smooth, thereby causing a defect of resulting in rough surface. Hence, it is not suited as the material of the sleeve 2. In this embodiment, the sleeve 2 is made of sulfur free-machining steel, and its surface is plated with a material primarily containing nickel and phosphorus, whereby the best results can be obtained in all of temperature characteristics, workability and wear resistance.

In this embodiment, a plastic working method referred to as the ball-rolling method is used to accurately form the dynamic pressure generation grooves 2C and 2D on the inner circumferential face of the bearing hole 2A of the sleeve 2 as shown in FIG. 2. As another processing method for the dynamic pressure generation grooves 2C and 2D, the electrolytic etching method is available. However, in this method, if the pitch interval is narrowed, even the smooth face of the inner face of the bearing hole 2A, other than the grooves, may be subjected to etching, whereby the accuracy of the bearing hole 2A deteriorates. In this embodiment, by using sulfur free-machining steel having relatively good plastic workability and suited for plastic working, the dynamic pressure generation grooves 2C and 2D, the most important portions in the hydrodynamic bearing, can be processed accurately. As the material of the sleeve 2, ferritic stainless steel, for example, can also be used. However, since ferritic stainless steel is very poor in plastic workability, the dynamic pressure generation grooves 2C and 2D cannot be processed accurately by the plastic working method, whereby a high-performance hydrodynamic bearing cannot be obtained.

In this embodiment shown in FIG. 1, description is made as to the type of hydrodynamic bearing wherein the shaft 1 rotates and the sleeve 2 is fixed, however, the present invention is also applicable to a type (not shown) of hydrodynamic bearing wherein the sleeve rotates together with the rotor hub and the shaft is fixed to the base, that is, a fixed-shaft type hydrodynamic bearing.

According to the present embodiment, since the radius clearance of the hydrodynamic bearing is small at high temperature and becomes large at low temperature, the changes in the characteristics of the hydrodynamic bearing owing to the change in the viscosity of the lubricant depending on temperature can be prevented. In addition, the wear resistance of the bearing, the workability of the sleeve and the workability of the dynamic pressure generation grooves are good, whereby an accurate hydrodynamic bearing can be obtained.

### Second Embodiment

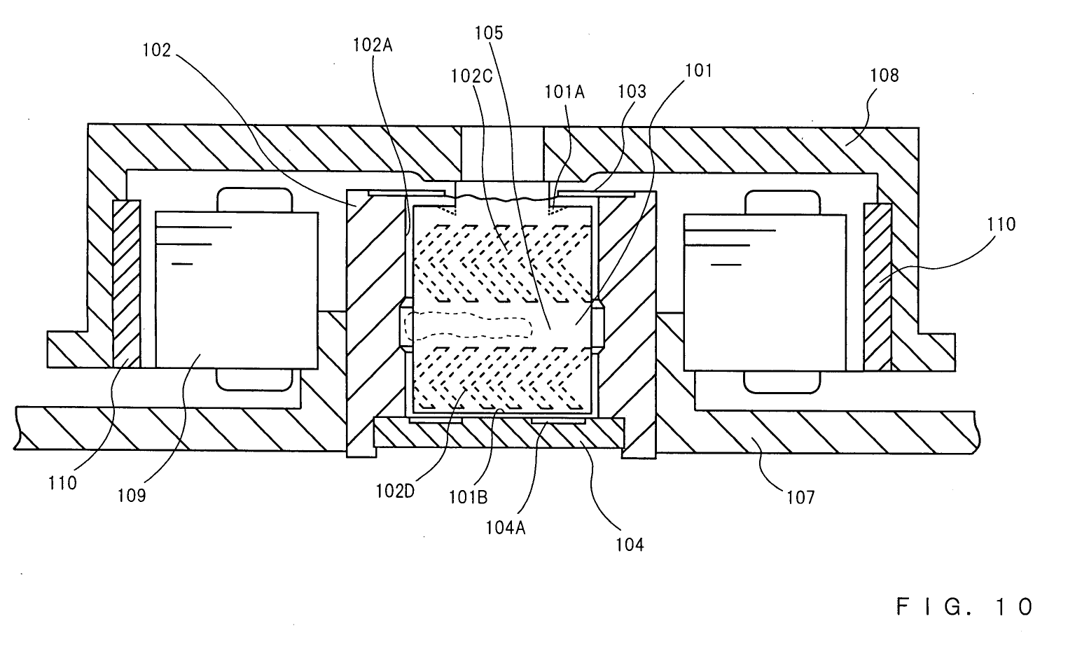

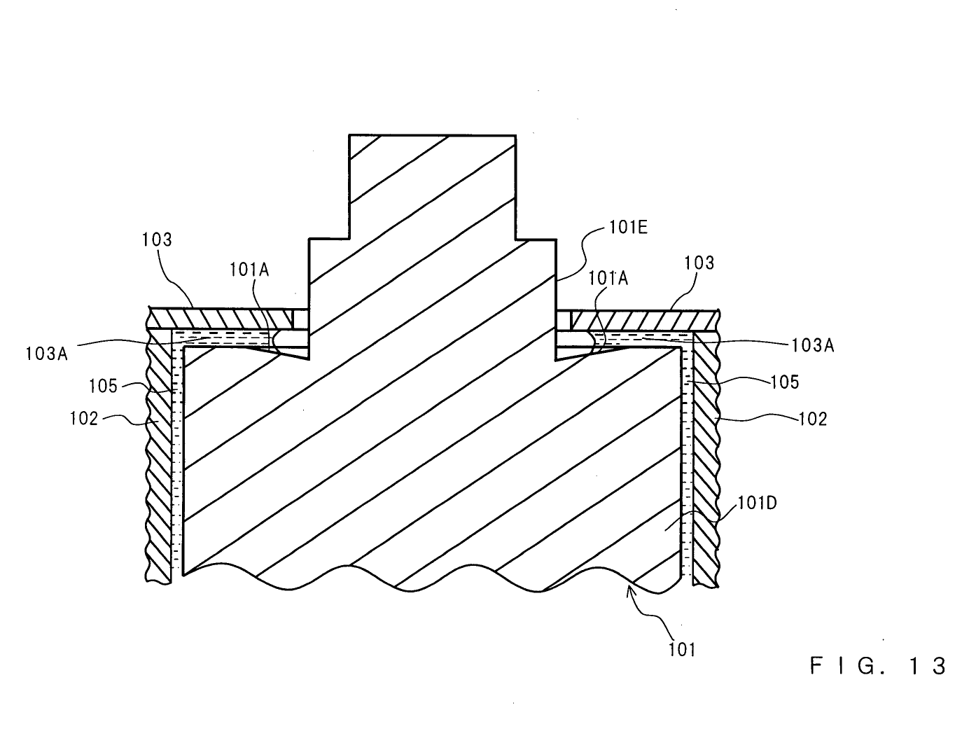

A hydrodynamic bearing in accordance with a second embodiment of the present invention will be described referring to FIGS. 10 to 13. FIG. 10 is a cross-sectional view of the hydrodynamic bearing in accordance with the second embodiment of the present invention. In the figure, a shaft 101 is rotatably inserted into the bearing hole 102A of a sleeve 102. As shown in FIG. 13 of a magnified cross-sectional view of the main portion, between the main body 101D and the small-diameter portion 101E of the shaft 101, a groove 101A is formed around the small-diameter portion 101E. The groove 101A is deepest at the small-diameter portion 101E and gradually becomes shallower toward the outer circumferential portion of the main body 101D.

In FIG. 10, a ring-shaped retainer 103 is mounted on the upper end of the sleeve 102 to prevent the shaft 101 from coming off from the sleeve 102. The inside diameter of the retainer 103 is set so as to cover about a half of the above-mentioned groove 101A as shown in the magnified view of FIG. 13. Dynamic pressure generation grooves 102C and 102D of herringbone-pattern-shaped shallow grooves are provided on at least one of the outer circumferential face of the shaft 101 and the inner circumferential face of the sleeve 102, whereby a radial bearing portion is formed. A rotor hub 108 having a rotor magnet 110 is mounted at the upper end portion of the shaft 101. The other end (the lower end portion in FIG. 10) of the shaft 101 has a shaft end face portion 101B which is a face perpendicular to the axis of the shaft 101. The shaft end face portion 101B is opposed to a thrust plate 104 fixed to the sleeve 102. A dynamic pressure generation groove 104A having a spiral shape or a fishbone shape (a herringbone shape) is formed on either one of the opposed faces of the shaft end face portion 101B and the thrust plate 104 (on the thrust plate 104 in FIG. 10), whereby a thrust bearing portion is formed. The sleeve 102 is fixed to a base 106 having a motor stator 109. The gap between the shaft 101 and the sleeve 102 and the gap between the shaft end face portion 101B and the thrust plate 4 are filled with a lubricant 105, such as oil.

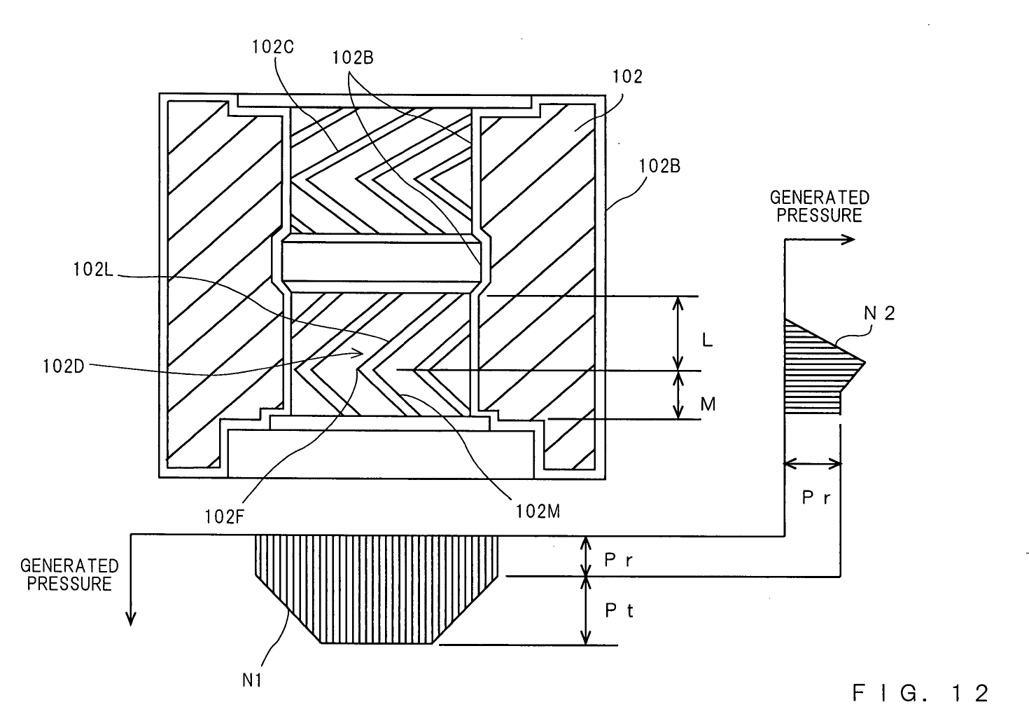

The shaft 101 is made of high manganese chromium steel containing 7 to 9 wt % of manganese and 13 to 15 wt % of chromium or austenitic stainless steel (containing 8 to 10 wt % of nickel and 17 to 19 wt % of chromium). The sleeve 102 is made of sulfur free-machining steel A or B or soft iron (containing little impurities, close to pure iron) listed in FIG. 7. The sulfur free-machining steel A contains 0.2 to 0.4 wt % of sulfur and 0.02 to 0.07 wt % of tellurium, and the sulfur free-machining steel B further contains 0.05 to 0.2 wt % of bismuth. FIG. 12 is a cross-sectional view of the sleeve 102. In the figure, the herringbone-shaped dynamic pressure generation grooves 102C and 102D are provided on the inner circumferential face of the sleeve 102 so as to be arranged in a direction along the axis (the same as the axis of the shaft 101 at the time when a hydrodynamic bearing is configured) of the sleeve 102. The length (the length corresponding to L in the figure) of the groove 102L provided upward from the turn-back portion 102F of the dynamic pressure generation groove 102D is longer than the length (the length corresponding to M in the figure) of the groove 102M provided downward. The outer surface of the sleeve 102 is coated with plating 102B made of a material primarily containing nickel and phosphorus and having a uniform thickness. The thickness of the plating is set appropriately in the range of 1 to 20 μm.

The operation of the hydrodynamic bearing in accordance with this embodiment configured as mentioned above will be described below. In FIG. 10, when electric power is applied to the motor stator 109, a rotating magnet field is generated, and the rotor magnet 110, the rotor hub 108 and the shaft 101 start rotating. By the rotation of the shaft 101, pumping pressures are generated in the lubricant such as oil in the dynamic pressure generation grooves 102C, 102D and 104A, and the oil pressures rise at the radial bearing portion and the thrust bearing portion. Hence, the shaft 101 is floated upward and rotates accurately without making contact with the thrust plate 104 and the sleeve 102.

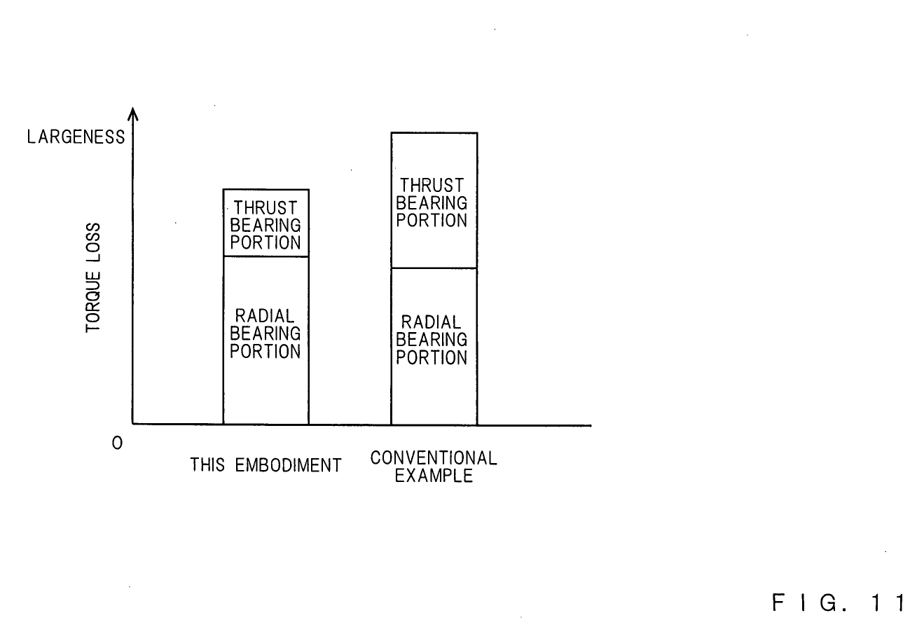

FIG. 11 is a graph showing details of torque loss at the time when the hydrodynamic bearing in accordance with this embodiment rotates at a predetermined rotation speed, wherein the hydrodynamic bearing in accordance with this embodiment is compared with the hydrodynamic bearing of the conventional example shown in FIG. 14. In the figure, the torque loss at the radial bearing portion of this embodiment is almost the same as that of the conventional example. The torque loss at the thrust bearing portion of the hydrodynamic bearing in accordance with this embodiment is far smaller than that of the conventional example. Although the hydrodynamic bearing of the conventional example has the flange 213 larger than the shaft 211 in diameter, the hydrodynamic bearing in accordance with this embodiment has no flange, and the shaft end face portion 101B having the same diameter as that of the shaft 101 functions as a flange. Since the diameter of the shaft end face portion 101B is smaller than that of the flange 213, the rotation resistance is smaller. As mentioned above, the total torque loss of the hydrodynamic bearing in accordance with this embodiment is smaller than that of the conventional example. Hence, in particular the increase in motor current at low temperature can be prevented.

In the hydrodynamic bearing in accordance with this embodiment, the sleeve 102 is provided with the retainer 103 for the shaft 101; hence, in the case when an abnormal acceleration is applied in the axial direction of the shaft 101 of the hydrodynamic bearing for example, the shaft 101 is prevented from coming off from the sleeve 102.

As another action of the retainer 103, as shown in FIG. 13, by making the clearance 103A between the retainer 103 and the upper end face of the shaft 101 larger than the dimension determined depending on the surface tension of the lubricant 105, such as oil, the lubricant 105 can be prevented from leaking from the upper end portion of the shaft 101 during the rotation of the hydrodynamic bearing. This is attained by using the action wherein the lubricant 105 does not leak from any clearance having the predetermined dimension or more owing to its surface tension. Hence, at least one of the lower face of the inner circumferential portion of the retainer 103 and the vicinity of the small-diameter portion 101E of the main body 101D of the shaft 101 is formed to have a nearly conical face. In this embodiment, as shown in FIG. 13, the groove 101A having a conical face is provided in the vicinity of the small-diameter portion 101E of the main body 101D. Hence, the clearance between the retainer 103 and the shaft 101 is wide in the inner circumferential side and narrow in the outer circumferential side. Since the lubricant 105 has a property of being held only in a narrow clearance portion owing to its surface tension, the lubricant 105 is held mainly at the outer circumferential portion having a narrow clearance but not held at the inner circumferential portion. In other words, the lubricant 105 does not come out to the wide clearance portion between the retainer 103 and the shaft 101, the opening portion of the hydrodynamic bearing. When the clearance between the groove 101A having a conical face and the end portion of the retainer 103 is set at the above-mentioned predetermined dimension, the lubricant 105 does not flow out; hence, the retainer 103 also has a function of preventing the leakage of the lubricant 105. Since the groove 101A is inclined, even if the vertical position of the shaft 101 is moved slightly, there is a position wherein the clearance between the retainer 103 and the groove 101A becomes the above-mentioned predetermined dimension, whereby the lubricant 105 does not leak.

Since the groove 102L of the dynamic pressure generation groove 102D is longer than the groove 102M (L>M) as shown in FIG. 12, when the shaft 101 rotates inside the sleeve 102 in the configuration shown in FIG. 10, the oil is pushed into the space between the shaft end face portion 101B and the thrust plate 104. Hence, the pressure at the shaft end face portion 101B rises and generates a large floating force in the thrust direction. In FIG. 12, when it is assumed that the pressure generated by the dynamic pressure generation grooves 102D in the thrust direction is represented by Pr and that the pressure generated by the dynamic pressure generation groove 104A in the thrust direction is represented by Pt, the pressure of the sum (Pr+Pt) of the pressure Pr and the pressure Pt is applied in the thrust direction. Curve N1 indicates the distribution of the above-mentioned pressure (Pr+Pt). In addition, curve N2 indicates the distribution of the pressure generated in the radial direction by the dynamic pressure generation grooves 102D.

FIG. 3 shows data obtained by measuring the linear expansion coefficients of various metals usable for the shaft 101 and the sleeve 102 in accordance with this embodiment. Also in this embodiment, just as in the case of the above-mentioned first embodiment, three kinds of materials, that is, high manganese chromium steel, austenitic stainless steel and martensitic stainless steel, are materials usable for the shaft 101. Three kinds of materials, that is, brass, sulfur free-machining steel and ferritic stainless steel, are usable for the sleeve 102. In this embodiment, high manganese chromium steel having a high linear expansion coefficient (having a linear expansion coefficient of 17 to 18×10⁻⁶) or austenitic stainless steel (having a linear expansion coefficient of 17.3×10⁻⁶) is used for the shaft 101. In addition, sulfur free-machining steel having a low linear expansion coefficient (having a linear expansion coefficient of 10 to 11.5×10⁻⁶) and excellent workability or soft iron is used for the sleeve 102. The following descriptions are made by using the figures common to the above-mentioned first embodiment.

FIG. 4 shows the change in the radius clearance between the shaft 101 and the bearing hole 102A of the sleeve 102 depending on temperature. Curve EAC indicates the upper limit value of tolerance, and curve FBD indicates the lower limit value of tolerance; the distance between these two curves corresponds to the range of tolerance. In this embodiment, since the above-mentioned materials are used for the shaft 101 and the sleeve 102, the radius clearance changes so as to becomes large at low temperature and to becomes small at high temperature. In the case when the diameter of the shaft 101 is 3.2 mm, when the temperature changes from 20° C. to 80° C., the radius clearance narrows by about 0.65 μm as shown in FIG. 4. In addition, when the temperature changes from 20° C. to −40° C., the radius clearance expands by about 0.65 μm. Since the bearing clearance changes as described above, even when the viscosity of the oil lowers at high temperature, the radius clearance narrows, whereby an effect of reducing the lowering of the rigidity of the bearing is obtained as shown in FIG. 5b. At low temperature, the radius clearance expands, whereby the increase of torque loss is restricted and the increase of the rotation resistance of the bearing is prevented as shown in FIG. 5a. Theoretically speaking, the rigidity of the bearing or the shaft swinging can be improved in proportion to the third power of the radius clearance. On the other hand, the torque loss of the bearing can be reduced in reverse proportion to the radius clearance.

FIG. 5a shows the torque loss, the increase of which is reduced by expansion of the radius clearance at −40° C. FIG. 5b shows the numeric values of the shaft swinging, the increase of which is restricted because the radius clearance narrows at +80° C. The range of the required performance is shown in each figure; however, in this embodiment, if the radius clearance is within the range of tolerance shown in FIG. 4, even if the radius clearance has a variation, the entire quantity of bearings can satisfy the required performance. In other words, all the 100% of production can be made nondefective.

FIG. 6 is a graph comparing the characteristics of the hydrodynamic bearing in accordance with this embodiment with the characteristics of the conventional hydrodynamic bearing shown in FIG. 14. In the hydrodynamic bearing in accordance with this embodiment, the torque loss at low temperature is restricted so as to be smaller. In addition, the shaft swinging at high temperature is also restricted so as to be smaller.

FIG. 7 is a table of ingredients of materials for the shaft 101 and the sleeve 102 in accordance with this embodiment, and each numeric value represents weight %.

FIG. 8 shows the results obtained by comparing and testing the wear resistance of the hydrodynamic bearing in the case of the combinations of metal materials for the shaft 101 and the sleeve 102 in the conventional hydrodynamic bearing and the hydrodynamic bearing in accordance with this embodiment. In this embodiment, since the surface of the sleeve 102 is coated with the plating 102B primarily containing nickel and phosphorus, its wear resistance is very excellent, and the long-term reliability of the bearing is high.

FIG. 9 shows the results obtained by measuring the cutting resistances of metal materials usable for the sleeve 102. Since the cutting resistance of brass is small, its workability is excellent; however, since its linear expansion coefficient is high as shown in FIG. 3, brass is not suitable. On the other hand, since ferritic stainless steel has large cutting resistance, it has poor workability; in the case when the surface of the bearing hole 102A of the sleeve 102 is machined, the surface cannot be machined so as to become smooth, thereby causing a defect of resulting in rough surface; hence, the steel is not suitable. In this embodiment, the best results can be obtained in all of temperature characteristics, workability and wear resistance by the effect obtained by the combination in which the sleeve 102 made of sulfur free-machining steel is machined, and its surface is coated with plating primarily containing nickel and phosphorus.

In a manner similar to the above-mentioned first embodiment, the ball-rolling method is employed to accurately machine at a predetermined pitch interval minute numerous grooves of the dynamic pressure generation grooves 102C and 102D, on the inner circumferential face of the bearing hole 102A of the sleeve 102 shown in FIG. 12. In the case of the conventional electrolytic etching method, if the pitch interval of the dynamic pressure generation grooves 102C and 102D is narrowed, even the smooth face of the inner face of the bearing hole 102A, other than the grooves, is subjected to etching. Hence, the accuracy of the bearing face deteriorates. Sulfur free-machining steel as a material for the sleeve 102 in accordance with this embodiment is relatively excellent in plastic workability, therefore, the dynamic pressure generation grooves 102C and 102D, which are particularly important in the hydrodynamic bearing can be processed accurately.

If the sleeve 102 made of ferritic stainless steel having poor plastic workability is tried to be machined, the dynamic pressure generation grooves 102C and 102D cannot be processed accurately, whereby the performance of the hydrodynamic bearing is lowered.

In this embodiment, a configuration wherein the sleeve 102 is fixed and the shaft 101 rotates is described; however, even in the case of a fixed-shaft type configuration wherein the sleeve 102 rotates together with the rotor hub 108 and the shaft 101 is fixed to the base 107, a working effect similar to that of this embodiment is obtained.

In this embodiment, since the thrust bearing portion is configured by the end face of the shaft 101 and the thrust plate 104, the diameter of the thrust bearing portion is restricted so as to be not more than the diameter of the shaft 101. In addition, since the radius clearance of the radial bearing portion becomes small at high temperature and becomes large at low temperature, the changes in the characteristics of the hydrodynamic bearing owing to the change in the viscosity of oil can be prevented. Furthermore, the workability of the sleeve and the workability of the dynamic pressure generation grooves which are the problems for mass production can be made best by using the materials having excellent workability as described above, and a hydrodynamic bearing excellent in wear resistance can be obtained.

### INDUSTRIAL APPLICABILITY

The hydrodynamic bearing in accordance with the present invention can be used as a bearing for a rotation body required to rotate at high speed and with high accuracy.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

1. A hydrodynamic bearing comprising:
a sleeve having a bearing hole, said sleeve being configured of a material containing iron,
a shaft relatively rotatably inserted into said bearing hole of said sleeve, said shaft being configured of at least one of materials selected from high manganese chromium steel and austenitic stainless steel, and
a nearly disc-shaped flange fixed to one end of said shaft, said flange opposing to an end face of said sleeve at one face, and opposing to a thrust plate provided so as to hermetically seal an area including said end face of said sleeve at the other face thereof, wherein
first and second dynamic pressure generation grooves are provided on at least one of the inner circumferential face of said sleeve and the outer circumferential face of said shaft so as to be arranged in a direction along the axis of said shaft, and a third dynamic pressure generation groove is provided on at least one of the opposed faces of said flange and said thrust plate,
the gap between said bearing hole of said sleeve and said shaft including said first and second dynamic pressure generation grooves and the gap between said thrust plate and said flange are filled with a lubricant, and
either one of said sleeve and said shaft is mounted on a fixed base having the stator of an electric motor and the other is mounted on a rotation body having the rotor magnet of said electric motor.

2. A hydrodynamic bearing in accordance with claim 1, wherein in said first and second dynamic pressure generation grooves, the dynamic pressure generation grooves provided close to said flange are formed in a linear shape bent at a predetermined angle, and the length of the groove ranging from the bent portion toward said flange is shorter than the length of the groove ranging from the bent portion toward a direction opposite to said flange.

3. A hydrodynamic bearing in accordance with claim 1, wherein the material containing iron, said material constituting said sleeve is sulfur free-machining steel containing 0.2 to 0.4 wt % of sulfur and 0.02 to 0.07 wt % of tellurium.

4. A hydrodynamic bearing in accordance with claim 1, wherein the high manganese chromium steel for constituting said shaft contains 7 to 9 wt % of manganese and 13 to 15 wt % of chromium.

5. A hydrodynamic bearing in accordance with claim 1, wherein the sulfur free-machining steel for constituting said sleeve contains 0.2 to 0.4 wt % of sulfur, 0.02 to 0.07 wt % of tellurium and 0.05 to 0.2 wt % of bismuth.

6. A hydrodynamic bearing in accordance with claim 1, wherein said first and second dynamic pressure generation grooves have a herringbone pattern, and said third dynamic pressure generation groove has a spiral pattern or a herringbone pattern.

7. A hydrodynamic bearing in accordance with claim 1, wherein in said first and second dynamic pressure generation grooves, the dynamic pressure generation grooves provided close to the end face portion of said shaft are formed in a linear shape bent at a predetermined angle, and the length of the groove ranging from the bent portion toward said end face portion of said shaft is shorter than the length of the groove ranging from the bent portion toward a direction opposite to said end face portion of said shaft.

8. A hydrodynamic bearing in accordance with claim 1, wherein said sleeve is made of a material containing iron, and the surface of said sleeve is coated with plating containing nickel and phosphorus.

9. A hydrodynamic bearing in accordance with claim 1, wherein a retainer is provided at the open end of said sleeve to prevent said shaft from coming off.

10. A hydrodynamic bearing in accordance with claim 9, wherein a ring-shaped groove becoming deeper toward the axis of said shaft is provided on the face of said shaft opposed to said retainer.

11. A hydrodynamic bearing comprising:
a sleeve having a bearing hole, said sleeve being made of a material containing iron,
a shaft relatively rotatably inserted into said bearing hole of said sleeve, said shaft being configured of at least one of materials selected from high manganese chromium steel and austenitic stainless steel, one end portion of said shaft having a shaft end face portion formed of a face perpendicular to the axis thereof, and
a thrust plate for forming a thrust bearing portion, by opposing to said shaft end face portion, wherein
first and second dynamic pressure generation grooves are provided on at least one of the inner circumferential face of said sleeve and the outer circumferential face of said shaft so as to be arranged in a direction along the axis of said shaft, and a third dynamic pressure generation groove is provided on at least one of the opposed faces of said shaft end face portion and said thrust plate,
the gap between said bearing hole of said sleeve and said shaft including said first, second and third dynamic pressure generation grooves and the gap between said shaft end face portion and said thrust plate are filled with a lubricant, and
either one of said sleeve and said shaft is mounted on a fixed base having the stator of an electric motor and the other is mounted on a rotation body having the rotor magnet of said electric motor.

12. A hydrodynamic bearing in accordance with claim 11, wherein the material containing iron, said material constituting said sleeve is sulfur free-machining steel containing 0.2 to 0.4 wt % of sulfur and 0.02 to 0.07 wt % of tellurium.

13. A hydrodynamic bearing in accordance with claim 11, wherein the high manganese chromium steel constituting said shaft contains 7 to 9 wt % of manganese and 13 to 15 wt % of chromium.

14. A hydrodynamic bearing in accordance with claim 11, wherein the sulfur free-machining steel constituting said sleeve contains 0.2 to 0.4 wt % of sulfur, 0.02 to 0.07 wt % of tellurium and 0.05 to 0.2 wt % of bismuth.

15. A hydrodynamic bearing in accordance with claim 11, wherein said first and second dynamic pressure generation grooves have a herringbone pattern, and said third dynamic pressure generation groove has a spiral pattern or a herringbone pattern.

16. A hydrodynamic bearing in accordance with claim 11, wherein in said first and second dynamic pressure generation grooves, the dynamic pressure generation grooves provided close to said shaft end face portion are formed in a linear shape bent at a predetermined angle, and the length of the groove ranging from the bent portion toward said shaft end face portion is shorter than the length of the groove ranging from the bent portion toward a direction opposite to said shaft end face portion.

17. A hydrodynamic bearing in accordance with claim 11, wherein said sleeve is made of a material containing iron, and the surface of said sleeve is coated with plating containing nickel and phosphorus.

18. A hydrodynamic bearing in accordance with claim 11, wherein a retainer is provided at the open end of said sleeve to prevent said shaft from coming off.

19. A hydrodynamic bearing in accordance with claim 18, wherein a ring-shaped groove being deeper toward the axis of said shaft is provided on the face of said shaft opposed to said retainer.
